(19) United States
(12) Patent Application Publication
(10) Pub. No.: US 2023/0038290 A1
(43) Pub. Date: Feb. 9, 2023

(54) FLAT BAR

(71) Applicant: Daniel J. Raymond, Saginaw, MI (US)

(72) Inventor: Daniel J. Raymond, Saginaw, MI (US)

(21) Appl. No.: 17/881,869

(22) Filed: Aug. 5, 2022

Related U.S. Application Data
(60) Provisional application No. 63/229,612, filed on Aug. 5, 2021.

(51) Int. Cl. B66F 15/00

(52) U.S. Cl. CPC B66F 15/00

(57) ABSTRACT

The multi-use flat bar includes a generally L-shaped body, which has a long leg and a short leg. The body also has a pair of side edges that extend along a full length of the body including both the long leg and the short leg. The long leg of the body has a first surface that is provided with angle measuring indicia, which includes a plurality of lines that extend from one of the side edges and point towards an opposite side edge in the short leg of the body.

### CROSS-REFERENCE TO RELATED APPLICATION

This application claims priority to U.S. Provisional Application No. 63/229,612, filed on Aug. 5, 2021, entitled “IMPROVED FLAT BAR,” the entire contents of which is hereby incorporated by reference.

### BACKGROUND

### 1. Field

The present disclosure is related generally to flat bars, such as those of the type commonly used in the construction trades.

### 2. Related Art

Flat bars find uses in a range of construction and maintenance purposes including, for example, roofing. Most flat bars are generally L-shaped with a long leg that defines a flat end and a short end that defines a prying end. Both ends are beveled and notched so they can be driven between two objects (for example, roof shingles) and used to pry those objects apart. Many flat bars also include one or more openings formed into a flat portion thereof for receiving and pulling nails.

### SUMMARY AND ADVANTAGES

One aspect of the present disclosure is related to a multi-use flat bar that includes a generally L-shaped body, which has a long leg and a short leg. The body also has a pair of side edges that extend along a full length of the body including both the long leg and the short leg. The long leg of the body has a first surface that is provided with angle measuring indicia, which includes a plurality of lines that extend from one of the side edges and point towards an opposite side edge in the short leg of the body.

According to another aspect of the present disclosure, the side edges are spaced apart from one another by a constant width along the entire length of the body including both the long leg and the short leg.

According to yet another aspect of the present disclosure, the body is made as a monolithic piece of metal.

According to still another aspect of the present disclosure, the metal is steel or an alloy steel.

According to a further aspect of the present disclosure, the short leg defines a foot that extends in a direction opposite of the first surface of the long leg of the body that has the angle measuring indicia.

According to yet a further aspect of the present disclosure, the long leg of the body further includes a second surface that is provided with length measuring indicia.

According to still a further aspect of the present disclosure, the long leg of the body defines a shank and the short leg of the body defines a foot.

According to another aspect of the present disclosure, the shank includes a crown that extends at an obtuse angle relative to the remaining portion of the shank.

According to yet another aspect of the present disclosure, ends of both of the shank and the foot define V-shaped notches.

Another aspect of the present disclosure is related to a method of making a multi-use flat bar. The method includes the step of shaping a body that is generally L-shaped with a long leg and a short leg and includes a pair of side edges that extend along a full length of the body including both the long leg and the short leg. The method also includes the step of forming onto a first surface of the long leg of the body, angle measuring indicia that includes a plurality of lines which extend from one of the side edges of the long leg of the body and point towards an opposite side edge in the short leg of the body.

According to another aspect of the present disclosure, after the step of shaping the body, the side edges are spaced apart from one another by a constant width along the entire length of the body including both the long leg and the short leg.

According to yet another aspect of the present disclosure, the body is made as a monolithic piece of metal.

According to still another aspect of the present disclosure, after the step of shaping the body, the short leg defines a foot that extends in a direction opposite of the first surface of the long leg of the body that has the angle measuring indicia.

According to a further aspect of the present disclosure, the long leg of the body further includes a second surface opposite of the first surface, and the method further includes the step of forming onto the second surface a length measuring indicia.

According to yet a further aspect of the present disclosure, after the step of forming the body, the long leg of the body defines a shank and the short leg of the body defines a foot.

According to still a further aspect of the present disclosure, after the step of forming the body, the shank includes a crown that extends at an obtuse angle relative to the remaining portion of the shank.

According to another aspect of the present disclosure, the method further includes the step of forming V-shaped notches into ends of both the shank and the foot of the body.

Yet another aspect of the present disclosure is related to a method of measuring an angle using a flat bar. The method includes the step of providing a flat bar body that is generally L-shaped with a long leg and a short leg and includes a pair of side edges that extend along a full length of the body including both the long leg and the short leg, the long leg of the body having a first surface that is provided with angle measuring indicia that include a plurality of lines which extend from one of the side edges and point towards an opposite side edge in the short leg of the body. The method further includes the step of resting the short leg of the body against a work piece. The method continues with the step of tilting the flat bar body with one of the side edges of the short leg resting against the work piece to line up a portion of the work piece with one of the plurality of lines on the first surface of the body to measure an angle.

According to another aspect of the present disclosure, the method further includes the step of using one of the side edges of the flat bar body as a guide to draw a straight line at the measured angle.

According to yet another aspect of the present disclosure, the method further includes the step of flipping the flat bar body so that the angle measuring indicia on the first surface of the body faces towards the workpiece and measuring an object on the workpiece using length measurement indicia on a second surface of the body.

### BRIEF DESCRIPTION OF THE DRAWINGS

These and other features and advantages of the present disclosure will become more readily appreciated when considered in connection with the following description of the presently preferred embodiments, appended claims and accompanying drawings, in which:

FIG. 1 is a perspective view of an exemplary embodiment of a flat bar;

FIG. 2 is another perspective view of the exemplary embodiment of the flat bar taken from a different view than FIG. 1;

FIG. 3 is a front elevation view of the exemplary embodiment of the flat bar;

FIG. 4 is a rear elevation view of the exemplary embodiment of the flat bar;

FIG. 5 is yet another perspective view of the exemplary embodiment of the flat bar taken from a different view than FIGS. 1 and 2;

FIG. 6 is an elevation view showing the exemplary embodiment of the flat bar being used as a straight edge and as a ruler; and

FIG. 7 is an elevation view showing the exemplary embodiment of the flat bar being used to measure an angle and draw a line at that angle.

### DESCRIPTION OF THE ENABLING EMBODIMENT

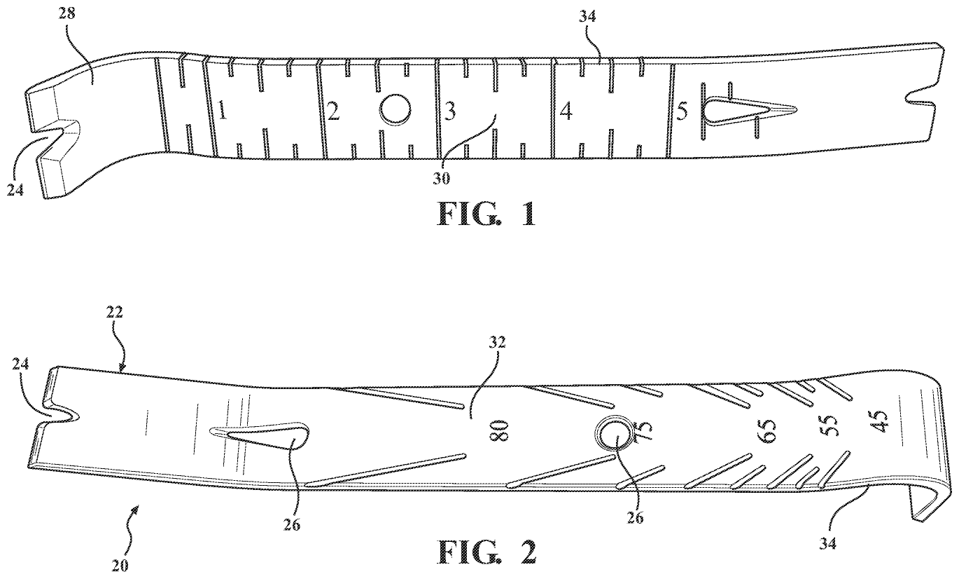

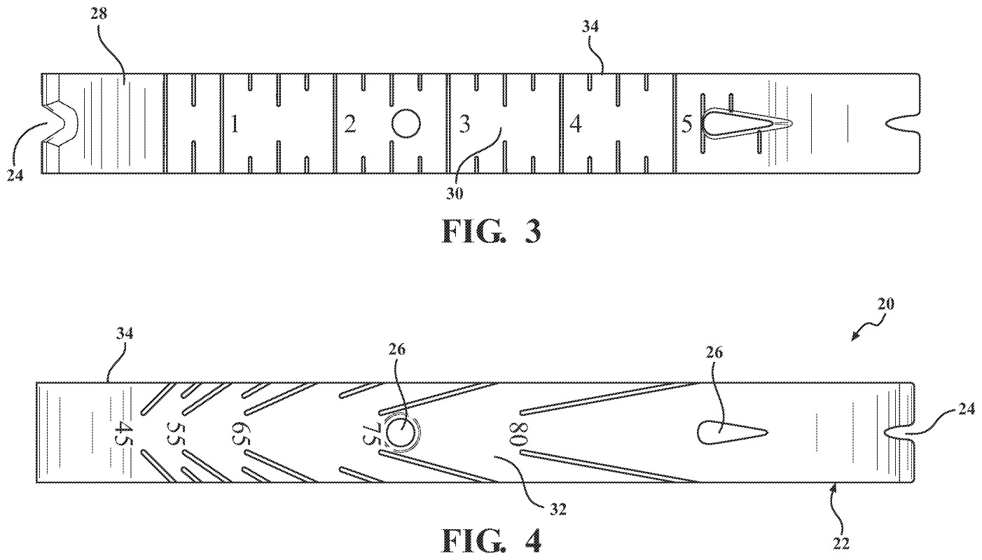

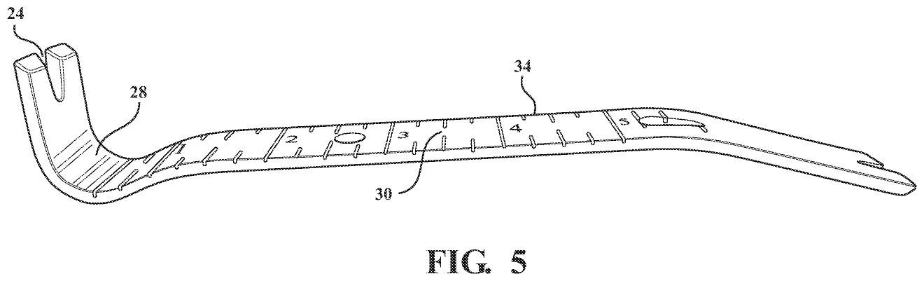

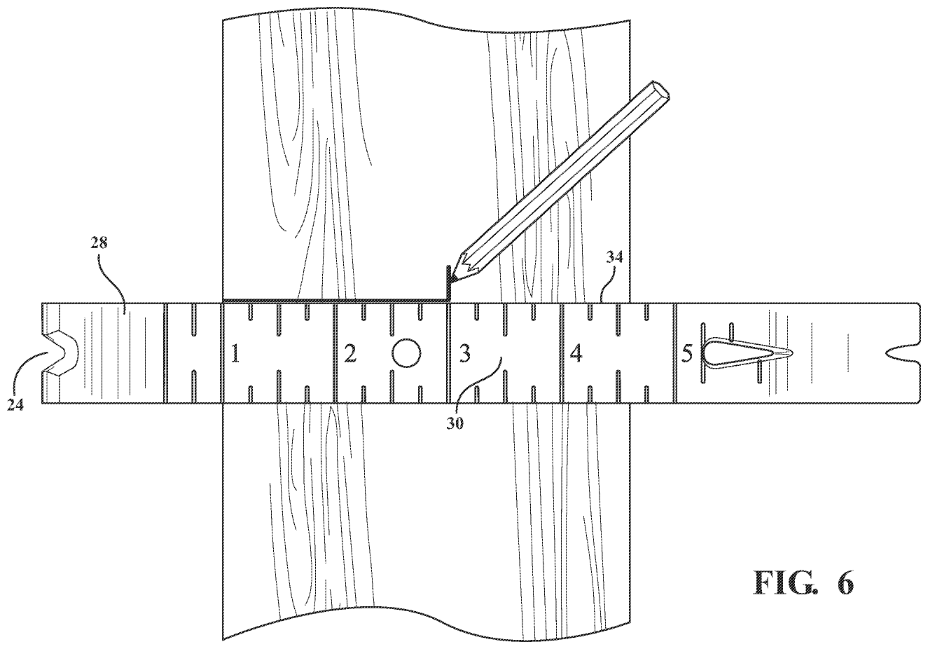

FIG. 1 is a perspective view of an exemplary embodiment of a flat bar 20 that is constructed according to one aspect of the present disclosure. The flat bar 20 includes a body that is generally L-shaped with a long leg and a short leg. The flat bar 20 of the exemplary embodiment has a length of approximately fifteen inches (15″) and has a generally constant thickness of approximately one quarter of an inch (¼″). The flat bar 20 is preferably made as a single, monolithic piece of steel or an alloy steel. However, any suitable type of material may be employed including, for example, other types of metals or composite materials. The flat bar 20 may be shaped according to any suitable process or combination of processes, including stamping, forging, casting, bending, machining, etc.

The long leg of the flat bar 20 defines a shank portion that extends to a distal end at a crown 22. The crown 22 is at least partially bent (such as at a radius or an angle) so that it also is angled relative to rest of the shank portion. An end of the crown 22 presents a V-shaped notch 24 that is configured to receive and pull nails, spikes, and other objects. A pair of additional openings 26 are also provided in the shank portion spaced from the V-shaped notch 24 for pulling nails or spikes of extended lengths. One of the openings may be located on the angled crown 22 portion and the other of the openings may be disposed on the part of the shank portion between the crown 22 and the short leg of the L-shaped flat bar 20.

The short leg of the flat bar 20 defines a foot 28 that extends generally perpendicularly to the shank portion on one side of the flat bar 20. The foot 28 also includes a V-shaped notch 24 that is configured to receive and pull nails, spikes, and other objects. The area where the foot 28 is connected with the shank portion is curved partially in a direction opposite of the direction that the foot 28 extends.

The shank portion has two opposing generally flat surfaces that face away from one another. One of those surfaces is a first surface 32 which faces in an opposite direction, and the other of those surfaces is a second surface 30, which is on the same side of the shank portion as the direction of extension of the foot 28. The flat bar 20 also includes parallel side edges 34 that extend between the first and second surfaces 32, 30 along the full length of the flat bar 20, including both the shank portion and the foot 28. The flat bar 20 has a consistent width, which is defined as the distance between the parallel side edges 34, along its full length from the end of the shank portion with the V-shaped notch 24 to the end of the foot 28 with the V-shaped notch 24.

On the second surface 30, the shank portion is provided with ruler indicia for taking measurements of objects or for allowing a user to trace along one of the side edges 34 to draw a line of a desired length. The ruler indicia could be in any suitable units, e.g., imperial (inches) or metric (centimeter). In an alternate embodiment, one side edge 24 could be associated with one measurement unit (for example, imperial units), and the other side edge could be associated with a different measurement unit (for example, metric units).

On the first surface 32, the shank portion is provided with a plurality of angle measuring indicia. Adjacent each side edge 34 of the shank portion, the angle measuring indica includes a plurality of lines that all face directly towards an opposite side edge of the foot 28. In other words, each line extends from one side edge 34 on the shank portion towards a location along a line along which the opposite side edge 34 extends in the foot 28. This configuration allows a user to measure an angle by rotating or pivoting the flat bar 20 about either of the side edges 34 in the foot 28 and using the indicia on the opposite side edge 34 of the shank portion. The first surface 32 of the shank portion thus has two sets of angle measuring indicia with lines that diverge from one another, one set is adjacent each side edge 34. One set of angle measuring indicia is used when measuring an angle using one of the side edges 34 in the foot 28, and the other set of angle measuring indicia is used when using the other side edge 34 in the foot 28.

In the exemplary embodiment, the lines of the angle measuring indicia are associated with degrees. In another embodiment, the lines can be associated with common cut angles, e.g., 2:12, 4:12, 8:12, 10:12, 14:12, and 16:12 common cuts. In yet another example, one set of lines can be associated with degrees, and the other set of lines can be associated with common cut angles.

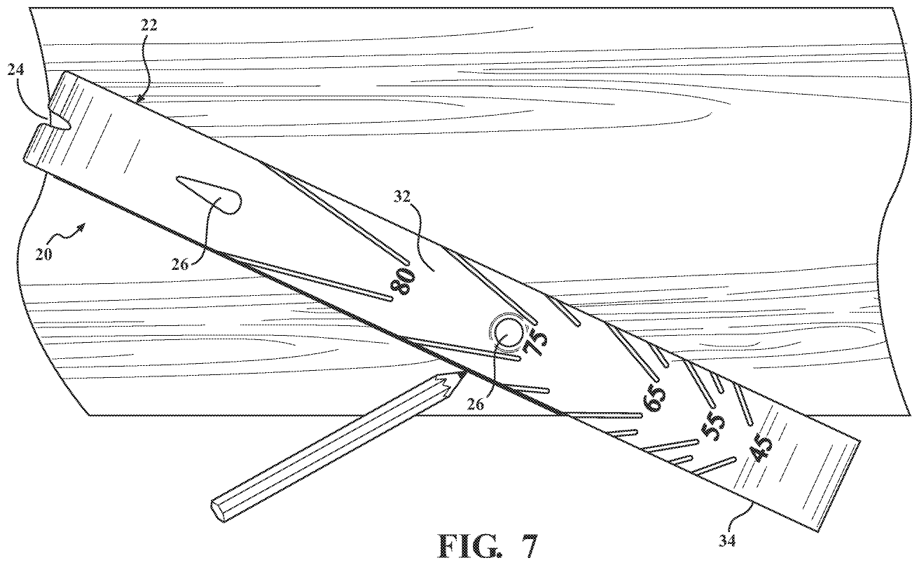

As illustrated in FIG. 7, use of the flat bar 20 to measure an angle on a workpiece or to draw a straight line at a defined angle on a workpiece involves placing a flat surface of the foot 28 of the flat bar 20 against a edge of the workpiece. The user then rotates the flat bar 20 about one of the side edges 34 of the foot 28. If the user is measuring an angle of a feature, the user then aligns one of the side edges 34 of the shank portion with the feature being measured. Whichever line on the angle measurement indicia lines up with the edge of the workpiece will then identify the angle of the feature. If the user is using the flat bar 20 to draw a line at a defined angle, then the user aligns the edge of the workpiece up with the line of the angle that the user intends to draw. The user can then use either of the side edges 24 of the shank portion as a straight edge to draw a line at the defined angle using a drawing utensil.

Obviously, many modifications and variations of the present invention are possible in light of the above teachings and may be practiced otherwise than as specifically described while within the scope of the appended claims. Additionally, it is to be understood that all features of all claims and all embodiments can be combined with each other as long as they do not contradict each other.

What is claimed is:

1. A multi-use flat bar, comprising:
a body that is generally L-shaped with a long leg and a short leg and includes a pair of side edges that extend along a full length of the body including both the long leg and the short leg; and
the long leg of the body having a first surface that is provided with angle measuring indicia that include a plurality of lines which extend from one of the side edges and point towards an opposite side edge in the short leg of the body.

2. The multi-use flat bar as set forth in claim 1, wherein the side edges are spaced apart from one another by a constant width along the entire length of the body including both the long leg and the short leg.

3. The multi-use flat bar as set forth in claim 1, wherein the body is made as a monolithic piece of metal.

4. The multi-use flat bar as set forth in claim 2, wherein the metal is steel or an alloy steel.

5. The multi-use flat bar as set forth in claim 1, wherein the short leg defines a foot that extends in a direction opposite of the first surface of the long leg of the body that has the angle measuring indicia.

6. The multi-use flat bar as set forth in claim 1 wherein the long leg of the body further includes a second surface that is provided with length measuring indicia.

7. The multi-use flat bar as set forth in claim 1 wherein the long leg of the body defines a shank and the short leg of the body defines a foot.

8. The multi-use flat bar as set forth in claim 7 wherein the shank includes a crown that extends at an obtuse angle relative to the remaining portion of the shank.

9. The multi-use flat bar as set forth in claim 7 wherein ends of both of the shank and the foot define V-shaped notches.

10. A method of making a multi-use flat bar, comprising the steps of:
shaping a body that is generally L-shaped with a long leg and a short leg and includes a pair of side edges that extend along a full length of the body including both the long leg and the short leg; and
forming onto a first surface of the long leg of the body, angle measuring indicia that includes a plurality of lines which extend from one of the side edges of the long leg of the body and point towards an opposite side edge in the short leg of the body.

11. The method of making the multi-use flat bar as set forth in claim 10, wherein after the step of shaping the body, the side edges are spaced apart from one another by a constant width along the entire length of the body including both the long leg and the short leg.

12. The method of making the multi-use flat bar as set forth in claim 10, wherein the body is made as a monolithic piece of metal.

13. The method of making the multi-use flat bar as set forth in claim 10, wherein after the step of shaping the body, the short leg defines a foot that extends in a direction opposite of the first surface of the long leg of the body that has the angle measuring indicia.

14. The method of making the multi-use flat bar as set forth in claim 10, wherein the long leg of the body further includes a second surface opposite of the first surface and further including the step of:
forming onto the second surface a length measuring indicia.

15. The method of making a multi-use flat bar as set forth in claim 10, wherein after the step of forming the body, the long leg of the body defines a shank and the short leg of the body defines a foot.

16. The method of making a multi-use flat bar as set forth in claim 15, wherein after the step of forming the body, the shank includes a crown that extends at an obtuse angle relative to the remaining portion of the shank.

17. The method of making the multi-use flat bar as set forth in claim 16, further including the step of forming V-shaped notches into ends of both the shank and the foot of the body.

18. A method of measuring an angle using a flat bar, comprising the steps of:
providing a flat bar body that is generally L-shaped with a long leg and a short leg and includes a pair of side edges that extend along a full length of the body including both the long leg and the short leg, the long leg of the body having a first surface that is provided with angle measuring indicia that include a plurality of lines which extend from one of the side edges and point towards an opposite side edge in the short leg of the body;
resting the short leg of the body against a work piece; and
tilting the flat bar body with one of the side edges of the short leg resting against the work piece to line up a portion of the work piece with one of the plurality of lines on the first surface of the body to measure an angle.

19. The method of measuring an angle using the flat bar as set forth in claim 18, further comprising the step of using one of the side edges of the flat bar body as a guide to draw a straight line at the measured angle.

20. The method of measuring an angle using the flat bar as set forth in claim 18 further including the step of flipping the flat bar body so that the angle measuring indicia on the first surface of the body faces towards the workpiece and measuring an object on the workpiece using length measurement indicia on a second surface of the body.
